(19) United States
(12) Patent Application Publication
(10) Pub. No.: US 2017/0129475 A1
(43) Pub. Date: May 11, 2017

(54) ELECTRIFIED VEHICLE POWERTRAIN MODE SELECTION SYSTEM AND METHOD

(71) Applicant: FORD GLOBAL TECHNOLOGIES, LLC, Dearborn, MI (US)

(72) Inventors: Kwaku O. Prakah-Asante, Commerce Twp., MI (US); Venkataramani Anandan, Farmington Hills, MI (US); Satish B. Chikkannanavar, Canton, MI (US)

(21) Appl. No.: 14/933,352

(22) Filed: Nov. 5, 2015

(51) Int. Cl. B60W 20/20; B60K 6/365; B60K 6/40; B60W 10/06; B60W 10/08; B60K 6/445; B60W 50/14

(52) U.S. Cl. CPC B60W 20/20; B60K 6/445; B60K 6/365; B60W 50/14; B60W 10/06; B60W 10/08; B60K 6/40; B60W 2550/20; B60Y 2300/182; B60Y 2200/92; Y10S 903/911; Y10S 903/93; Y10S 903/951

(57) ABSTRACT

An exemplary adaptive drive control method includes receiving an input that characterizes a condition outside of an electrified vehicle, and using a powertrain mode controller to select an Auto-EV mode, EV-Later, or an EV-Now mode in response to the input.

### TECHNICAL FIELD

This disclosure relates generally to powertrain operating modes for an electrified vehicle. More particularly, the disclosure relates to receiving an input that characterizes a condition outside the electrified vehicle, and then selecting a powertrain operating mode in response to the input.

### BACKGROUND

Electrified vehicles differ from conventional motor vehicles because electrified vehicles are selectively driven using one or more electric machines powered by a battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

Some electrified vehicles can operate the powertrain in different powertrain modes. For example, the powertrain can be operated in an Auto-EV or EV-Now mode. In the Auto-EV mode an internal combustion engine is used in combination with an electric machine to selectively power the vehicle. In the EV-Now mode, the electric machine is used to power the vehicle.

Some electrified vehicles provide a driver with the ability to select powertrain modes to manage energy usage. The driver sometimes selects a particular powertrain mode even though another powertrain mode would prove to be more beneficial.

### SUMMARY

An adaptive drive control method according to an exemplary aspect of the present disclosure includes, among other things, receiving an input that characterizes a condition outside of an electrified vehicle, and using a powertrain mode controller to select an Auto-EV mode or an EV-Now mode in response to the input.

In a further non-limiting embodiment of the foregoing method, the method includes using the powertrain mode controller to select an EV-Later mode in response to the input.

In a further non-limiting embodiment of any of the foregoing methods, the condition comprises an upcoming traffic condition.

In a further non-limiting embodiment of any of the foregoing methods, the condition comprises a location condition for the electrified vehicle.

In a further non-limiting embodiment of any of the foregoing methods, the method includes prompting a user to switch from the Auto-EV mode to the EV-Now mode, or from the EV-Now mode to the Auto-EV mode in response to the selecting.

In a further non-limiting embodiment of any of the foregoing methods, the method includes receiving an authorization to switch from the Auto-EV mode to the EV-Now mode, or from the EV-Now mode to the Auto-EV mode in response to the prompting.

In a further non-limiting embodiment of any of the foregoing methods, the authorization is received from a driver interacting with a human machine interface.

In a further non-limiting embodiment of any of the foregoing methods, the method includes automatically switching from the Auto-EV mode to the EV-Now mode, or from the EV-Now mode to the Auto-EV mode in response to the input.

In a further non-limiting embodiment of any of the foregoing methods, the Auto-EV mode drives vehicle drive wheels using an internal combustion engine, an electric machine, or both. The EV-Now mode drives vehicle drive wheels using an electric machine without the internal combustion engine.

A powertrain mode selection system according to an exemplary aspect of the present disclosure includes, among other things, a receiver configured to receive an input that characterizes a condition outside of an electrified vehicle, and a controller configured to select an Auto-EV mode or an EV-Now mode in response to the input.

In a further non-limiting embodiment of the foregoing system, the controller is further configured to select an EV-Later mode in response to the input.

In a further non-limiting embodiment of any of the foregoing systems, the system includes an internal combustion engine and an electric machine. The internal combustion engine, the electric machine, or both are configured to drive vehicle wheels when operating in the Auto-EV mode. The electric machine is configured to drive vehicle wheels without the internal combustion engine when operating in the EV-Now mode.

In a further non-limiting embodiment of any of the foregoing systems, the condition comprises an upcoming traffic condition.

In a further non-limiting embodiment of any of the foregoing systems, the condition comprises a location condition for the electrified vehicle.

In a further non-limiting embodiment of any of the foregoing systems, the controller is further configured to prompt a user to switch from the Auto-EV mode to the EV-Now mode, or from the EV-Now mode to the Auto-EV mode in response to the selection.

In a further non-limiting embodiment of any of the foregoing systems, the controller is further configured to receive an authorization to switch from the Auto-EV mode to the EV-Now mode, or from the EV-Now mode to the Auto-EV mode in response to the authorization.

In a further non-limiting embodiment of any of the foregoing systems, the system includes a human machine interface. The controller is configured to receive the authorization from a driver input to the human machine interface.

In a further non-limiting embodiment of any of the foregoing systems, the controller is configured to select and automatically switch from the Auto-EV mode to the EV-Now mode, or from the EV-Now mode to the Auto-EV mode in response to the input.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 shows an example electrified vehicle powertrain.

FIG. 2 shows a highly schematic view of a vehicle having the powertrain of FIG. 1 and incorporating an example powertrain operating mode selection system.

FIG. 3 shows a highly schematic view of another example powertrain operating mode selection system for use with the powertrain of FIG. 2.

### DETAILED DESCRIPTION

This disclosure relates generally to selecting an operating mode for a powertrain of an electrified vehicle. More particularly, the disclosure is directed toward a system that selects the operating mode based on inputs received from outside the electrified vehicle.

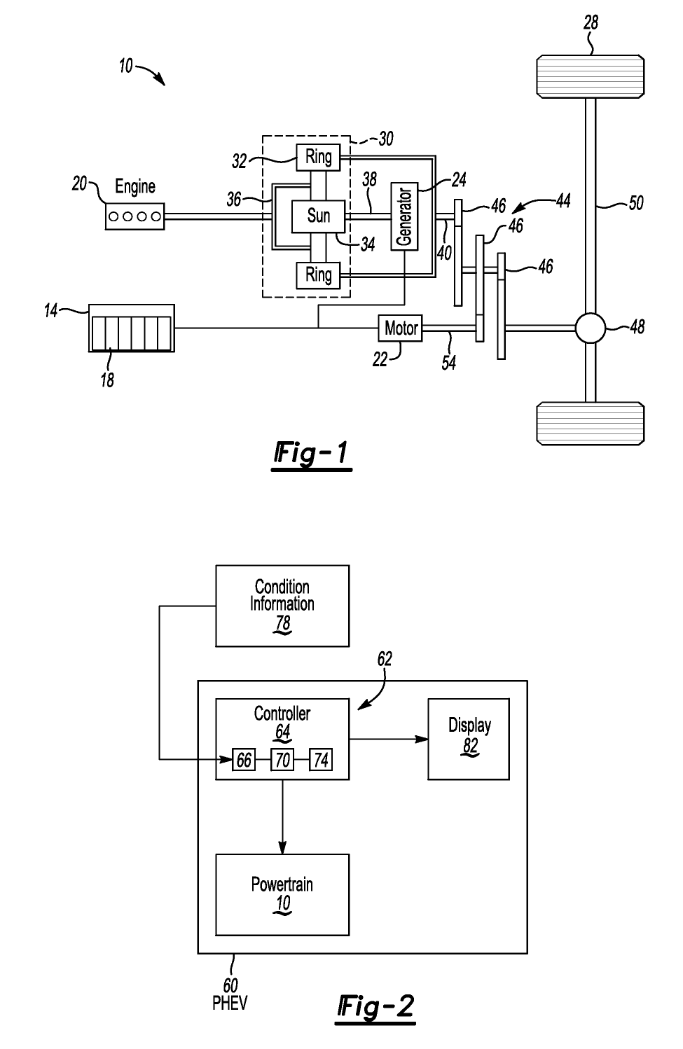

Referring to FIG. 1, a powertrain 10 of a plug-in hybrid electric vehicle (PHEV) includes a traction battery 14 having a plurality of individual battery cells 18. The powertrain 10 further includes an internal combustion engine 20, a motor 22, and a generator 24. The motor 22 and the generator 24 are types of electric machines. The motor 22 and generator 24 may be separate or have the form of a combined motor-generator.

In this embodiment, the powertrain 10 is a power-split powertrain that employs a first drive system and a second drive system. The first and second drive systems generate torque to drive one or more sets of vehicle drive wheels 28. The first drive system includes a combination of the engine 20 and the generator 24. The second drive system includes at least the motor 22, the generator 24, and the battery 14. The motor 22 and the generator 24 are portions of an electric drive system of the powertrain 10.

The engine 20 and the generator 24 can be connected through a power transfer unit 30, such as a planetary gear set. Of course, other types of power transfer units, including other gear sets and transmissions, can be used to connect the engine 20 to the generator 24. In one non-limiting embodiment, the power transfer unit 30 is a planetary gear set that includes a ring gear 32, a sun gear 34, and a carrier assembly 36.

The generator 24 can be driven by the engine 20 through the power transfer unit 30 to convert kinetic energy to electrical energy. The generator 24 can alternatively function as a motor to convert electrical energy into kinetic energy, thereby outputting torque to a shaft 38 connected to the power transfer unit 30.

The ring gear 32 of the power transfer unit 30 is connected to a shaft 40, which is connected to the vehicle drive wheels 28 through a second power transfer unit 44. The second power transfer unit 44 may include a gear set having a plurality of gears 46. Other power transfer units could be used in other examples.

The gears 46 transfer torque from the engine 20 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 can be selectively employed to drive the vehicle drive wheels 28 by outputting torque to a shaft 54 that is also connected to the second power transfer unit 44. In this embodiment, the motor 22 and the generator 24 cooperate as part of a regenerative braking system in which both the motor 22 and the generator 24 can be employed as motors to output torque. For example, the motor 22 and the generator 24 can each output electrical power to recharge cells of the battery 14.

Referring to FIG. 2 with continuing reference to FIG. 1, an example PHEV 60 includes a powertrain operating mode selection system 62 having a powertrain mode controller 64 operably coupled to the powertrain 10. The controller 64 can provide an input to the powertrain 10 that causes the powertrain 10 to operate in at least an Auto-EV mode or an EV-Now mode.

In the Auto-EV mode, the engine 20, the motor 22, or both can power the drive wheels 28. In the EV-Now mode, the drive wheels 28 are powered by the motor 22, but not the engine 20. The Auto-EV mode is generally considered a default powertrain mode for normal operation of the electrified vehicle. The EV-Now mode is generally considered an electric only operating mode.

In addition to the Auto-EV and the EV-Now modes, the example controller 64 can provide an input to the powertrain that causes the powertrain 10 to operate in an EV-Later mode. In the EV-Later mode, the powertrain 10 operates to conserve power that is stored within the battery 14. In some examples, the powertrain 10 operates in the EV-Later mode so that power can be conserved and stored in preparation for an extended period of operation in the EV-Now mode.

A person having skill in this art and the benefit of this disclosure would understand how to command an electrified vehicle powertrain to operate in an Auto-EV, EV-Now, or EV-Later mode.

The example controller 64 includes a receiver 66, a processor 70, and a memory portion 74. The receiver 66 can receive, among other things, information about conditions outside the PHEV 60. Example information received by the receiver 66 of the controller 64 can include traffic condition information, driving route information, and location information. Information received by the receiver 66 from outside the PHEV 60 is represented schematically as condition information 78.

Notably, the example controller 64 selects the operating mode for the powertrain 10 based, at least in part, on the condition information 78 that is received by the receiver 66 from outside the PHEV 60.

The receiver 66 can receive the information through wireless communications. For example, traffic condition information could be transmitted wirelessly from traffic condition monitoring location to a satellite and then to the receiver 66.

Some known electrified vehicles can switch from, for example, an Auto-EV mode to an EV-Now mode, but this switch is not based on information from outside the vehicle. Instead, the switch is based on information within the vehicle, such as decreasing request for power by the vehicle.

The processor 70 of the controller 64 can be programmed to execute a program stored in the memory portion 74. The program can be stored in the memory portion 74 as software code. The program stored in the memory portion 74 can include one or more additional or separate programs, each of which includes an ordered listing of executable instructions for implementing logical functions associated with the powertrain operating modes of the PHEV 60. For example, based at least in part on the condition information 78 received by the receiver 66, the program executed on the controller 64 causes the controller 64 to select an EV-Now or an Auto-EV mode.

The controller 64, in this example, is operably coupled to a display 82 within the PHEV 60. The display 82 can be a touch-screen display within a passenger cabin of the PHEV 60. The display 82 can be part of a human-machine interface for the PHEV 60.

In some examples, the controller 64 can respond to the condition information 78 received by the receiver 66 by selecting an operating mode for the powertrain 10 and displaying a prompt on a screen of the display 82 showing the selected mode.

After the controller 64 selects an EV-Now or an Auto-EV mode, the prompt presents a driver of the PHEV 60 with an option to switch from the Auto-EV mode to the EV-Now mode, or from the EV-Now mode to the Auto-EV mode. The driver of the PHEV 60 can interact with the display 82 to authorize the controller 64 to switch the powertrain 10 to the powertrain mode selected by the controller 64.

In some examples, the controller 64 automatically switches the powertrain 10 to the selected powertrain mode rather than selecting a powertrain mode and confirming the selection with the driver prior to switching the powertrain 10 to the selected powertrain mode.

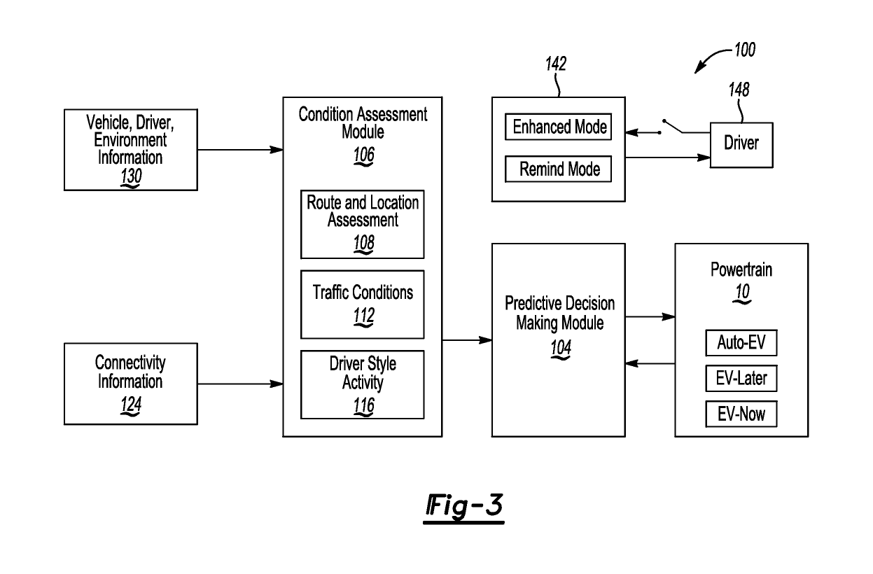

Referring now to FIG. 3 with continuing reference to FIGS. 1 and 2, and exemplary block diagram representation of another example powertrain mode selection system 100 includes a predictive decision making module 104 and a condition assessment module 106. Generally, the predicted decision making module 104 is an example of the controller 64 in FIG. 2, and the condition assessment module 106 is an example of the condition information 78 in FIG. 2.

The predictive decision making module 104 can place the powertrain 10 in at least the Auto-EV mode, the EV-Later mode, or the EV-Now mode. The placement of the powertrain 10 in a particular mode is based on, among other things, information from the condition assessment module 106.

The example condition assessment module 106 retrieves and compiles information, such as information from a route and location assessment module 108, a traffic condition module 112, and a driver style activity module 116. The route and location assessment module 108, the traffic condition module 112, and the driver style activity module 116 are types of information that can be provided as inputs to the predictive decision making module 104.

The predictive decision making module 104 can receive, directly or indirectly, other inputs such as vehicle information, driver information, environment information represented as block 130; and connectivity information represented as block 134. The vehicle information within the block 130 can include state of charge information for the battery 14 (FIG. 1) of the powertrain 10. The vehicle information within the block 130 can instead, or additionally, include speed, acceleration pedal position, steering wheel angle, brake status, longitudinal acceleration, lateral acceleration and various vehicle parameters available from the vehicle network bus. Additional environment and connectivity information within block 130 include distance and velocity of surrounding vehicles from external sensing systems, vehicle location from Global Positioning Systems (GPS), and navigation systems.

In one example, the predictive decision making module 104 selects an EV-Later mode for the PHEV 60 if a state of charge for the battery 14 is relatively high, and if the information from the route and location assessment module 108 provides information to the predictive decision making module 104 that the PHEV will soon travel a route with a high likelihood of stop-and-go traffic. At least the route and location assessment module relies on information obtained from outside the PHEV 60.

In another example, the predictive decision making module 104 selects an operating mode for the PHEV 60 based, among other things, an upcoming traffic state, a location of the PHEV 60, current location traffic, and driving style.

The Decision Table below shows the combinations of these variables that cause the exemplary predictive decision making module 104 to select the EV-Later, the EV-Now, or the Auto-EV mode. A selection of the EV-Later, EV-Now, or Auto-EV mode is indicated with a “Y” in the Decision Table. Additional roles for expanded scenarios could be included.

DECISION TABLE

| TRAFFIC | CURRENT | | DRIVER | | | |
|---|---|---|---|---|---|---|
| CONDITION | TRAFFIC | LOCATION | STYLE | | | |
| UPCOMING | CONDITION | ID | ACTIVITY | SELECT | SELECT | SELECT |
| (TCU) | (CTC) | (LID) | (DSA) | EV-LATER? | EV-Now? | AUTO-EV? |
| >alpha | <beta | 1 | >gamma | Y | N | N |
| <alpha | >beta | 1 or 0 | <gamma | N | Y | N |
| <alpha | <beta | 1 or 0 | >gamma | N | N | Y |
| Not available | >beta | 1 or 0 | <gamma | N | Y | N |
| Not available | >beta | 1 or 0 | >gamma | N | N | Y |

As shown in the Decision Table, the predictive decision making module 104 selects the EV-Later mode if the Traffic Condition Upcoming (TCU) is greater than alpha, the Current Traffic Condition (CTC) is less than beta, the Location ID (LID) is 1, and the Driving Style Activity (DSA) is greater than gamma.

The exemplary TCU is a unitless number representing further upcoming traffic intensity, which can be between 0 and 1. The route and location assessment module 108 could utilize frequently traveled route information from a navigation system of the PHEV 60 to determine TCU. Methods of predicted upcoming traffic conditions for a vehicle are known and could be understood by a person having skill in this art and the benefit of this disclosure. The TCU characterizes a condition outside the PHEV 60 and relies on information from outside the PHEV 60.

In this example, a traffic intensity, which is scaled as a value with range from 0 to 1, is based on traffic flow and a number of vehicles in upcoming areas. TCU values closer to 1 represent higher upcoming traffic density and values closer to 0 represent low traffic intensity. Alpha is a unitless tunable threshold value which may be predetermined and stored in the predictive decision making module 104. For example, TCU values greater than an alpha value of 0.8 (TCU>0.8) can represent the threshold for upcoming high intensity traffic along the driver route and can indicate conditionally using EV-Later, should other conditions hold.

The exemplary CTC is a unitless number representing current traffic intensity surrounding the vehicle, which can be between 0 and 1. An analysis of information relating to a driver's engagement with a brake pedal and an accelerator pedal of the PHEV 60 can be used to calculate the CTC for the PHEV 60. Increasing engagements with the brake pedal and accelerator pedal indicate increasing stop and go traffic, for example. The CTC can be provided as a value with a range from 0 to 1, with values closer to 1 reflecting higher traffic conditions (higher stop-and-go), and values closer to 0 representing lower traffic conditions (lower stop-and-go). Environmental conditions for the PHEV 60 from radar sensors, vision sensors and other environmental sensors could also be used in addition to the driver's engagement with the brake pedal and accelerator pedal to calculate the CTC. Techniques for predicting traffic conditions based on pedal actuations are known and could be understood by a person having skill in the art and the benefit of this disclosure.

In this example, Beta is a unitless tunable threshold value, which can be predetermined and stored in the predictive decision making module 104. For example, CTC values greater than a beta threshold value of 0.7 (CTC>0.7) can represent high intensity traffic surrounding the driver and may indicate conditionally using EV-Now, if other conditions are met.

The LID of 1 corresponds to the PHEV 60 being on a highway, and a LID of 0 corresponds to the PHEV 60 not being on the highway. A speed profile for the PHEV 60 and an output from a navigation system of the PHEV 60 can be used to determine whether or not the PHEV 60 is on a highway. The LID characterizes a condition outside the PHEV 60 and relies on information from outside the PHEV 60 (e.g., GPS information).

The exemplary DSA is a value representing a driver style and provides a relative range for cautious driving styles to aggressive driving styles. Methods of calculating DSA for an operating vehicle are known and could be understood by a person having skill in this art and the benefit of this disclosure.

Driver activity with the acceleration pedal and steering wheel angle can be used to determine the driver style. The variability of the driver activity with the accelerator pedal and steering wheel may be recursively computed and scaled to obtain a DSA value with range from 0 to 1 to represent driving style. DSA values closer to 1 can reflect more aggressive driving, and values closer to 0, can represent more cautious driving.

In this example, gamma is a unitless tunable threshold value, which may be predetermined and stored in the predictive decision making module 104. For example, DSA values greater than a gamma threshold value of 0.75 (DSA>0.75) can represent the threshold for characterizing aggressive driving behavior, and DSA values less than the gamma threshold value of 0.75 can represent cautious driving.

Location information where more cautious driving is required could cause the predictive decision making module 104 to place the powertrain 10 of the PHEV 60 in a certain mode, and can override the mode indicated in the Decision Table. Maps and GPS systems could provide the location information. For example, certain geographic locations where cautious driving may be required, such as areas around schools and residential areas, can be recognized by the predictive decision making module 104. The predictive decision making module 104 then selects the EV-Now mode for the PHEV 60 in response to the PHEV 60 entering or approaching these areas.

The predictive decision making module 104 could also recognize geographic locations where aggressive and cautious driving behavior has been experienced by the PHEV 60. If, for example, significant cautious driving behavior over time in a particular geographic location is recognized, the GPS coordinates of that location can be stored within the predictive decision making module 104. If the vehicle drives through a cluster of GPS coordinates and has cautious driving demand recognized again, a more frequent cautious driving area is created and a predictive signal sent to the predictive decision making module 104.

A driving style could cause the predictive decision making module 104 to select a certain mode for operating the powertrain 10 of the PHEV 60. Driving style can be based on driver interaction with, among other things, driver interaction with the steering wheel, brake pedal, and accelerator pedal. If the predictive decision making module 104 calculates that the driving style is aggressive, the predictive decision making module 104 can override the mode indicated in the Decision Table. If the predictive decision making module 104 calculates that the driving style is cautious, the predictive decision making module 104 can permit the mode indicated by the Decision Table.

Driving styles can be provided to the predictive decision making module 104 as a value with a range from 0 to 1, with values closer to 1 reflecting more aggressive driving, and values closer to 0 representing more cautious driving. Exemplary approaches for quantifying driving styles would be understood by a person having skill in this art and the benefit of this disclosure.

At the block 142, the example powertrain mode selection system 100 is shown to be operable in an enhanced mode or a remind mode. In the enhanced mode, the predictive decision making module 104 selects a mode and then places the powertrain 10 in that mode. In the reminding mode, the predictive decision making module 104 selects a mode and then prompts the driver, represented by block 148, to authorize a change to the selected mode, or to maintain the powertrain 10 in the current mode. In the remind mode, the selecting of a mode by the predictive decision making module 104 provides the driver with a prompt, such as a visual display, audible cue, or both, indicating the predictive decision making module 104 selection necessitates changing powertrain operating modes. The driver can then choose to authorize the change with an input on a touch screen or an audible response, for example.

Features of the disclosed examples include selecting a powertrain operating mode in response to, at least in part, an input that characterizes a condition outside to an electrified vehicle. The selecting can reveal, in some situations, a more efficient mode for operating the powertrain than if the selecting is based on input from a driver.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. An adaptive drive control method, comprising:
receiving an input that characterizes a condition outside of an electrified vehicle; and
using a powertrain mode controller to select an Auto-EV mode or an EV-Now mode in response to the input.

2. The method of claim 1, further comprising using the powertrain mode controller to select an EV-Later mode in response to the input.

3. The method of claim 1, wherein the condition comprises an upcoming traffic condition.

4. The method of claim 1, wherein the condition comprises a location condition for the electrified vehicle.

5. The method of claim 1, further comprising prompting a user to switch from the Auto-EV mode to the EV-Now mode, or from the EV-Now mode to the Auto-EV mode in response to the selecting.

6. The method of claim 5, further comprising receiving an authorization to switch from the Auto-EV mode to the EV-Now mode, or from the EV-Now mode to the Auto-EV mode in response to the prompting.

7. The method of claim 6, wherein the authorization is received from a driver interacting with a human machine interface.

8. The method of claim 1, including automatically switching from the Auto-EV mode to the EV-Now mode, or from the EV-Now mode to the Auto-EV mode in response to the input.

9. The method of claim 1, wherein the Auto-EV mode drives vehicle drive wheels using an internal combustion engine, an electric machine, or both, wherein the EV-Now mode drives vehicle drive wheels using an electric machine without the internal combustion engine.

10. A powertrain mode selection system, comprising:
a receiver configured to receive an input that characterizes a condition outside of an electrified vehicle; and
a controller configured to select an Auto-EV mode or an EV-Now mode in response to the input.

11. The system of claim 10, wherein the controller is further configured to select an EV-Later mode in response to the input.

12. The system of claim 10, further comprising an internal combustion engine and an electric machine, wherein the internal combustion engine, the electric machine, or both are configured to drive vehicle wheels when operating in the Auto-EV mode, wherein the electric machine is configured to drive vehicle wheels without the internal combustion engine when operating in the EV-Now mode.

13. The system of claim 10, wherein the condition comprises an upcoming traffic condition.

14. The system of claim 10, wherein the condition comprises a location condition for the electrified vehicle.

15. The system of claim 10, wherein the controller is further configured to prompt a user to switch from the Auto-EV mode to the EV-Now mode, or from the EV-Now mode to the Auto-EV mode in response to the selecting.

16. The system of claim 10, wherein the controller is further configured to receive an authorization to switch from the Auto-EV mode to the EV-Now mode, or from the EV-Now mode to the Auto-EV mode in response to the authorization.

17. The system of claim 16, further comprising a human machine interface, the controller configured to receive the authorization from a driver input to the human machine interface.

18. The system of claim 10, wherein the controller is configured to select and automatically switch from the Auto-EV mode to the EV-Now mode, or from the EV-Now mode to the Auto-EV mode in response to the input.
